(19) United States
(12) Patent Application Publication
(10) Pub. No.: US 2016/0029698 A1
(43) Pub. Date: Feb. 4, 2016

(54) ELECTRONIC CIGARETTE AND INFORMATION COLLECTION METHOD

(71) Applicant: HUIZHOU KIMREE TECHNOLOGY CO., LTD, Huizhou (CN)

(72) Inventor: Zhiyong XIANG, Huizhou (CN)

(21) Appl. No.: 14/799,094

(22) Filed: Jul. 14, 2015

Related U.S. Application Data
(63) Continuation of application No. PCT/CN2014/083377, filed on Jul. 31, 2014.

(51) Int. Cl. A24F 47/00

(52) U.S. Cl. CPC A24F 47/008; H04W 84/12

(57) ABSTRACT

An electronic cigarette provided in the embodiments of the present application includes an electronic cigarette body. The electronic cigarette body is provided with a smoking end, an atomizer assembly for atomizing a cigarette liquid, and a battery assembly for supplying power to the atomizer assembly. The electronic cigarette body is further provided with a detection module, a microprocessor and a wireless signal transmission module. The detection module is configured to detect a rotation angle and an acceleration of the electronic cigarette body at a certain interval, the microprocessor is configured to calculate a motion trail of the electronic cigarette body according to a detection result of the detection module and transmit a calculation result to the wireless signal transmission module, and the wireless signal transmission module is configured to transmit the calculation result to a preset device bound with the electronic cigarette body.

### CROSS-REFERENCE TO RELATED APPLICATIONS

This application is a continuation under 35 U.S.C. §120 of PCT/CN2014/083377, filed Jul. 31, 2014, the entire content of which is incorporated herein by reference.

### TECHNICAL FIELD

The present application relates to the technical field of electronic cigarettes, and particularly to an electronic cigarette and an information collection method.

### BACKGROUND

An electronic cigarette, as a new type of electronic products, though having the same appearance and the same flavor with a conventional cigarette, is healthier and more environmental friendly compared to the conventional cigarette. In the electronic cigarette, a cigarette liquid containing nicotine and essence is atomized by an atomizing core into particles to be outputted. The electronic cigarette does not contain tar and other harmful ingredients which are contained in the conventional cigarette, and does not generate second-hand smoke either.

With the increase of the electronic cigarette users, more requirements are imposed by the users on the functions of the electronic cigarette. However, in conventional electronic cigarettes, most of the electronic cigarettes are merely presented as independent units, and do not have the function to communicate with a smart device, and a few of electronic cigarettes, having the function to communicate with a smart device, can merely transmit some simple data relevant to smoking to the smart device.

### SUMMARY

An electronic cigarette and an information collection method are provided according to the present application, which can enable the electronic cigarette to realize a function of controlling a preset device by motion sensing, such as the function of a motion sensing game handle.

An electronic cigarette is provided according to the present application, which includes an electronic cigarette body. The electronic cigarette body is provided with a smoking end, an atomizer assembly configured to atomize a cigarette liquid, and a battery assembly configured to supply power to the atomizer assembly. The electronic cigarette body is further provided with a detection module, a microprocessor and a wireless signal transmission module, and the detection module is configured to detect a rotation angle and an acceleration of the electronic cigarette body at a certain interval, the microprocessor is configured to calculate a motion trail of the electronic cigarette body according to a detection result of the detection module and transmit a calculation result to the wireless signal transmission module, and the wireless signal transmission module is configured to transmit the calculation result to a preset device bound with the electronic cigarette body.

In the electronic cigarette, the detection module includes a gyroscope and an acceleration meter.

In the electronic cigarette, the wireless signal transmission module is a Bluetooth transmission module, a wireless fidelity (WIFI) transmission module, an infrared transmission module or a near field communication (NFC) transmission module.

In the electronic cigarette, the electronic cigarette body is further provided with a luminous element configured to indicate a working state of the detection module, the microprocessor and the wireless signal transmission module.

In the electronic cigarette, the atomizer assembly and the battery assembly are coaxially arranged, the smoking end is provided at an end of the atomizer assembly away from the battery assembly, and the luminous element is provided at an end of the battery assembly away from the atomizer assembly.

In the electronic cigarette, the battery assembly includes a battery sleeve, a battery provided inside the battery sleeve, a sensing module configured to generate a triggering signal, and a microcontroller, and the microcontroller is configured to be electrically connected to the sensing module and configured to control the battery to supply power to the atomizer assembly according to the triggering signal.

In the electronic cigarette, the sensing module is further configured to transmit an activating signal to the microcontroller in the case that it is detected that the number of times of sucking the electronic cigarette within a preset duration is greater than a preset value; and the microcontroller is further configured to activate the detection module and the wireless signal transmission module according to the activating signal.

In the electronic cigarette, a liquid storage space configured to store the cigarette liquid, an atomizing core configured to atomize the cigarette liquid and to be electrically connected to the battery assembly, and a smoke passage configured to discharge smoke to the smoking end and extending along an axis of the atomizer assembly are provided in the atomizer assembly.

In the electronic cigarette, each of the detection module, the microprocessor and the wireless signal transmission module is arranged at an end of the battery assembly away from the liquid storage space.

The electronic cigarette further includes a liquid bottle connected to an end of the atomizer assembly away from the battery assembly. The atomizer assembly includes an atomizing bracket, an atomizing core fixed in the atomizing bracket and configured to atomize the cigarette liquid, and a liquid guiding mechanism configured to deliver the cigarette liquid in the liquid bottle to the atomizing core to be atomized The atomizing core includes an atomizing sleeve, an atomizing electrode assembly arranged at an end of the atomizing sleeve and configured to be electrically connected to the battery assembly, a liquid retaining member provided inside the atomizing sleeve and made of a liquid absorption material, and an electric heating wire assembly arranged inside the atomizing sleeve and located between the atomizing electrode assembly and the liquid retaining member, and the electric heating wire assembly is electrically connected to the atomizing electrode assembly. The liquid guiding mechanism includes a liquid guiding sleeve inserted in the liquid bottle, and a liquid guiding member inserted in the liquid guiding sleeve and made of a liquid absorption material, and a cross-sectional area of the liquid retaining member is smaller than a cross-sectional area of the liquid guiding member.

In the electronic cigarette, the liquid bottle and the atomizer assembly are detachably connected to each other.

In the electronic cigarette, a sealing ring with a through hole is arranged at an opening of the liquid bottle, and the liquid guiding mechanism is inserted into the liquid bottle through the through hole of the sealing ring, to allow the sealing ring and the liquid guiding mechanism to seal the liquid bottle.

In the electronic cigarette, the battery assembly and the atomizer assembly are detachably connected to each other.

An information collection method is further provided according to the present application, which includes:

collecting, by an electronic cigarette, a motion trail of the electronic cigarette at a certain interval; and

transmitting, by the electronic cigarette, the motion trail of the electronic cigarette to a preset device bound with the electronic cigarette.

In the information collection method, a gyroscope, an acceleration meter and a microprocessor are provided inside the electronic cigarette;

the collecting, by an electronic cigarette, a motion trail of the electronic cigarette at a certain interval includes:

collecting, by the gyroscope in the electronic cigarette, a rotation angle of the electronic cigarette at a certain interval;

collecting, by the acceleration meter in the electronic cigarette, an acceleration of the electronic cigarette at a certain interval; and

calculating, by the microprocessor in the electronic cigarette, the motion trail of the electronic cigarette at a certain interval according to rotation angles and accelerations at a certain interval.

In the information collection method, the transmitting, by the electronic cigarette, the current motion trail of the electronic cigarette to a preset device bound with the electronic cigarette includes:

transmitting, by the electronic cigarette, the current motion trail of the electronic cigarette to the preset device bound with the electronic cigarette via Bluetooth transmission, WIFI transmission, infrared transmission or NFC transmission.

The information collection method further includes:

starting to collect, by the electronic cigarette, the motion trail of the electronic cigarette at a certain interval in the case that it is detected that the number of times of sucking the electronic cigarette within a preset duration is greater than a preset value.

The information collection method further includes:

controlling, by the electronic cigarette, a first program of the preset device to be activated and starting to collect, by the electronic cigarette, the motion trail of the electronic cigarette at a certain interval in the case that it is detected that the number of times of sucking the electronic cigarette within the preset duration is greater than a first preset value and smaller than a second preset value; and

controlling, by the electronic cigarette, a second program of the preset device to be activated and starting to collect, by the electronic cigarette, the motion trail of the electronic cigarette at a certain interval in the case that it is detected that the number of times of sucking the electronic cigarette within the preset duration is greater than or equal to the second preset value and smaller than a third preset value.

The information collection method further includes: stopping, by the electronic cigarette, collecting the motion trail of the electronic cigarette in the case that it is detected that a duration of the electronic cigarette being placed horizontally or vertically is greater than a preset duration and the electronic cigarette is in a stationary state.

According to the above technical solutions, the present application has the following advantages.

In the present application, the detection module, the microprocessor and the wireless signal transmission module are provided inside the electronic cigarette body, and the detection module is configured to detect the rotation angle and the acceleration of the electronic cigarette body at a certain interval. The microprocessor is configured to calculate the motion trail of the electronic cigarette body according to the detection result of the detection module and transmit the calculation result to the wireless signal transmission module. The wireless signal transmission module is configured to transmit the calculation result to the preset device bound with the electronic cigarette. Therefore, the electronic cigarette may act as a motion sensing game handle, and be used together with a smart device having a motion sensing game function or used to correspondingly control the preset device. Due to the function extension of the electronic cigarette, the user experience of the electronic cigarette is enhanced.

### BRIEF DESCRIPTION OF THE DRAWINGS

FIG. 1 is a schematic sectional view showing the structure of an embodiment of an electronic cigarette according to the present application;

FIG. 2 is a schematic sectional view showing the structure of another embodiment of an electronic cigarette according to the present application;

FIG. 3 is a schematic sectional view showing the structure of an atomizing core in the electronic cigarette shown in FIG. 2; and

FIG. 4 is a flow chart of an embodiment of an information collection method according to the present application.

### DETAILED DESCRIPTION

An electronic cigarette is provided according to the present application, which is capable of realizing a function of controlling a preset device by motion sensing, such as acting as a motion sensing game handle.

The technical solutions in the embodiments of the present application will be described clearly and completely hereinafter in conjunction with the drawings in the embodiments of the present application. Apparently, the described embodiments are only a part of the embodiments of the present application, rather than all embodiments. Based on the embodiments in the present application, all of other embodiments, made by the person skilled in the art without any creative efforts, fall into the scope of the present application.

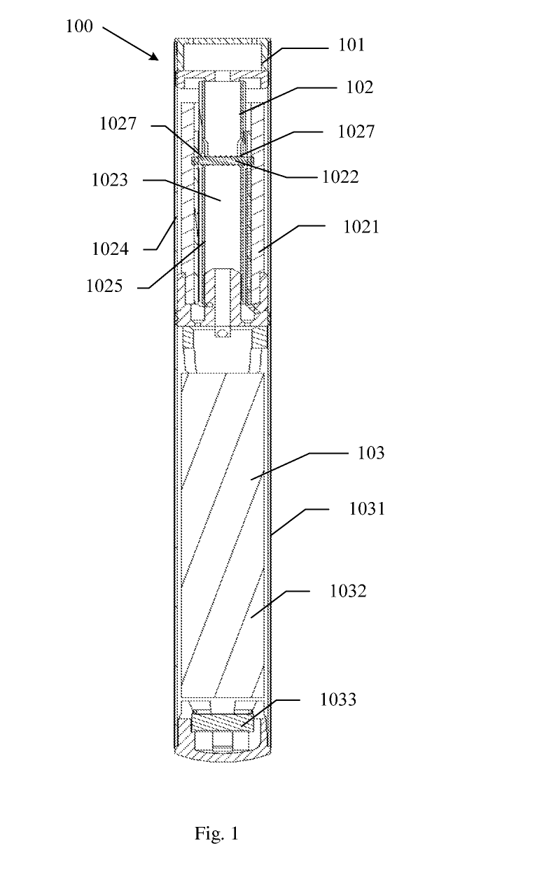

Reference is made to FIG. 1, which is a schematic view showing the structure of an embodiment of an electronic cigarette according to the present application. As shown in FIG. 1, this embodiment of the electronic cigarette according to the present application includes an electronic cigarette body.

An end of the electronic cigarette body is provided with a smoking end 101, and the user may smoke the electronic cigarette through the smoking end 101.

The electronic cigarette body is further provided with an atomizer assembly 102 for atomizing a cigarette liquid and a battery assembly 103 for supplying power to the atomizer assembly 102.

The electronic cigarette body is further provided with a detection module (not shown), a microprocessor (not shown) and a wireless signal transmission module (not shown). The detection module is configured to detect a rotation angle and an acceleration of the electronic cigarette body at a certain interval and transmit a detection result to the microprocessor. It can be appreciated by the person skilled in the art that, the certain interval may be set according to actual requirements. It is to be noted that, each of the rotation angle and the acceleration includes a specific value and a specific direction, i.e., both of them are vector values. In this embodiment, the detection module may include a gyroscope and an acceleration meter. The gyroscope is configured to detect the rotation angle of the electronic cigarette body, and the acceleration meter is configured to detect the acceleration of the electronic cigarette body. Of course, in practical application, the rotation angle and the acceleration of the electronic cigarette body may also be detected by other kinds of detection module, which is not limited herein.

The microprocessor is configured to calculate a motion trail of the electronic cigarette body according to the detection result of the detection module and transmit a calculation result to the wireless signal transmission module. The manner of calculating a motion trail of an object according to rotation angles and accelerations thereof belongs to the conventional technology, which is therefore not described herein.

The wireless signal transmission module is configured to transmit the calculation result to a preset device bound with the electronic cigarette. For example, the preset device may be a device with motion sensing games, such as a TV, a computer, a tablet computer or a cell phone, each of which has motion sensing games, which is not limited herein.

In practical application, the electronic cigarette may be bound with a preset device by various ways. For example, the electronic cigarette is provided with a signal transmission switch, and the electronic cigarette may transmit a signal when a user turns on the signal transmission switch on the electronic cigarette. When the signal is detected by the preset device, the user may input a preset personal identification number (PIN) code to formally connect the electronic cigarette to the preset device. The electronic cigarette stores the information code trusted by the user terminal, and the electronic cigarette can be automatically formally connected and bound with the preset device when a signal transmitted by the electronic cigarette is detected by the preset device next time. Of course, the above example is merely a description and does not intend to constitute limitation.

The wireless signal transmission module may be embodied as various kinds, for example a Bluetooth transmission module, a WIFI transmission module, an infrared transmission module or an NFC transmission module, which transmit the calculation result of the microprocessor to the preset device respectively via Bluetooth transmission, WIFI transmission, infrared transmission or NFC transmission. Of course, in practical application, the calculation result of the microprocessor may also be transmitted in other ways, which is not limited herein.

In the embodiment of the present application, the detection module, the microprocessor and the wireless signal transmission module are provided inside the electronic cigarette body, and the detection module can detect the rotation angle and the acceleration of the electronic cigarette body at a certain interval. The microprocessor calculates the motion trail of the electronic cigarette body according to the rotation angles and the accelerations of the electronic cigarette body and then transmits the calculation result to the wireless signal transmission module. The wireless signal transmission module transmits the calculation result to the preset device. Therefore, the electronic cigarette may act as a motion sensing game handle, and be used together with a smart device having a motion sensing game function. Due to the function extension of the electronic cigarette, the user experience of the electronic cigarette is enhanced.

Preferably, the detection module, the microprocessor and the wireless signal transmission module in the electronic cigarette body are normally in an off state. The electronic cigarette body is further provided with a switch for activating the detection module, the microprocessor and the wireless signal transmission module in the electronic cigarette body when the user needs to use the electronic cigarette as a motion sensing game handle. The switch may be a physical button arranged on the electronic cigarette body, and the user may turn on or turn off each of the detection module, the microprocessor and the wireless signal transmission module by pressing the button.

Preferably, the electronic cigarette body is further provided with a luminous element for indicating a working state of the detection module, the microprocessor and the wireless signal transmission module. For example, the luminous element is in a continuous light emitting state or in a flickering state when the detection module, the microprocessor and the wireless signal transmission module in the electronic cigarette body are in an on state. Of course, the luminous element may also indicate the working state of the detection module, the microprocessor and the wireless signal transmission module in other ways, which is not limited herein. In this way, it is convenient for the user to know whether the motion sensing game handle function of the electronic cigarette is activated, thereby enhancing the user experience.

In this embodiment, the atomizer assembly 102 and the battery assembly 103 are connected end to end and coaxially arranged, and the smoking end 101 is provided at an end of the atomizer assembly away from the battery assembly 103. With such arrangement, the appearance of the electronic cigarette visually simulates the real cigarette, and the integral smoke passage is straight, which may effectively reduce the phenomenon of liquid accumulation. Further, the smoking end 101 at the end of the atomizer assembly 102 may also be preferably coaxially arranged with the battery assembly 103, to enable the overall structure of the electronic cigarette to simulate the real cigarette more realistically, to conform with habit of users and reduce the liquid accumulation.

Preferably, the luminous element is arranged at an end of the battery assembly 103 away from the atomizer assembly 102. When the electronic cigarette acts as a cigarette, the luminous element may emit light continuously when the user is puffing on the electronic cigarette, to simulate the combustion of a real cigarette in smoking. When the electronic cigarette acts as a motion sensing game handle, the luminous element is in a mode, which is different from the continuous light emitting mode, to indicate the working state of the detection module, the microprocessor and the wireless signal transmission module, for example, the luminous element is in a flickering mode. In this way, there is no need to provide another luminous element on the electronic cigarette to indicate the working state of the detection module, the microprocessor and the wireless signal transmission module.

Of course, in practical application, the smoking end 101 may also be located at other positions on the electronic cigarette. The above described solution is only an example and is not intend to limit the specific position of the smoking end 101.

In this embodiment, a liquid storage space 1021 for storing the cigarette liquid and an atomizing core 1022 are provided in the atomizer assembly 102. The atomizing core 1022 is connected to the liquid storage space 1021, is configured to atomize the cigarette liquid in the liquid storage space 1021 and is electrically connected to the battery assembly 103. A liquid storage cotton is provided inside the liquid storage space 1021. Of course, in practical application, other liquid storage media may also be provided in the liquid storage space, or there is no liquid storage media in the liquid storage space, which is not limited herein.

In this embodiment, the atomizing core 1022 is embodied as an electric heating wire assembly. Of course, in practical application, the atomizing core may also be embodied as other forms, for example, an electric heating piece or an ultrasound atomizing assembly, and etc., which is not limited herein. A smoke passage 1023 for discharging smoke to the smoking end 101 is further provided in the atomizer assembly 102. The smoke passage 1023 connects the atomizing core 1022 with the smoking end 101 and is extending along an axis of the atomizer assembly 102.

In the present application, the atomizer assembly 102 in the electronic cigarette body can be implemented in various structures. A specific structure of the atomizer assembly of the electronic cigarette is described in detail hereinafter in conjunction with FIG. 1. Referring to FIG. 1, the atomizer assembly 102 further includes an atomizing sleeve 1024. A cylindrical holder 1025 is provided in the atomizing sleeve 1024. The holder 1025 may be a glass fiber tube. Of course, in practical application, the holder 1025 may also be made of other materials, which is not limited herein.

The liquid storage space 1021 surrounds an outer sidewall of the holder 1025, and the sidewall of the holder 1025 is further provided with a support hole 1027. The orientation of the support hole 1027 is perpendicular to the orientation of the holder 1025. The atomizing core 1022 passes through the support hole 1027 and is fixed inside the holder 1025, and two ends of the atomizing core 1022 are inserted into the liquid storage space 1021, to atomize the cigarette liquid inside the liquid storage space 1021. The smoke passage 1023 extends along a hollow portion of the holder 1025 and extends from the atomizing core 1022 to the smoking end 101.

In the present application, the battery assembly 103 in the electronic cigarette body can be implemented in various structures. A specific structure of the battery assembly of the electronic cigarette is described in detail in conjunction with FIG. 1. Referring to FIG. 1, the battery assembly 103 includes:
a battery sleeve 1031;
a battery 1032 inserted inside the battery sleeve 1031;
a sensing module 1033 for generating a triggering signal; and
a microcontroller (not shown) electrically connected to the sensing module 1033 and configured to control the battery to supply power to the atomizer assembly according to the triggering signal.

As shown in FIG. 1, in this embodiment, the sensing module is preferably embodied as an airflow sensing switch. The pressure inside the electronic cigarette is reduced when the user is smoking through the smoking end 101, and the airflow sensing switch 1033 generates a triggering signal when it detects that the pressure is reduced.

The microcontroller controls the battery 1032 of the battery assembly 103 to supply power to the electronic cigarette when the triggering signal is detected by the microcontroller, to allow the atomizing core 1022 of the electronic cigarette to atomize the cigarette liquid to form smoke to be inhaled by the user.

Of course, the way of arranging the sensing module is not limited to the way shown in FIG. 1. For example, an operating button may further be provided on a surface of the electronic cigarette, and when the user desires to smoke, the user can press the operating button, and the operating button may generate the triggering signal according to the operation of the user, and after the triggering signal is detected by the microcontroller, the microcontroller controls the battery 1032 of the battery assembly 103 to supply power to the electronic cigarette, to allow the atomizing core 1022 of the electronic cigarette to atomize the cigarette liquid to form smoke to be inhaled by the user.

Preferably, the sensing module is further configured to transmit an activating signal to the microcontroller when it is detected that the number of times of sucking the electronic cigarette within a preset duration is greater than a preset value. The microcontroller is further configured to activate the detection module and the wireless signal transmission module according to the activating signal. The preset value may be a default set by the sensing module, or may be set by the user.

In this way, the electronic cigarette is not required to additionally provide an activating switch, and the user may directly activate the motion sensing game handle function of the electronic cigarette by puffing on the electronic cigarette, thereby enhancing the user experience.

Preferably, the detection module, the microprocessor and the wireless signal transmission module are arranged at an end of the battery assembly away from the liquid storage space. In this way, when the cigarette liquid leaks from the liquid storage space, the detection module, the microprocessor and the wireless signal transmission module won't be corroded. Further, the detection module, the microprocessor and the wireless signal transmission module may also be arranged in the battery sleeve 1031 of the battery assembly at an end away from the liquid storage space, thus the battery sleeve 1031 can protect the detection module, the microprocessor and the wireless signal transmission module.

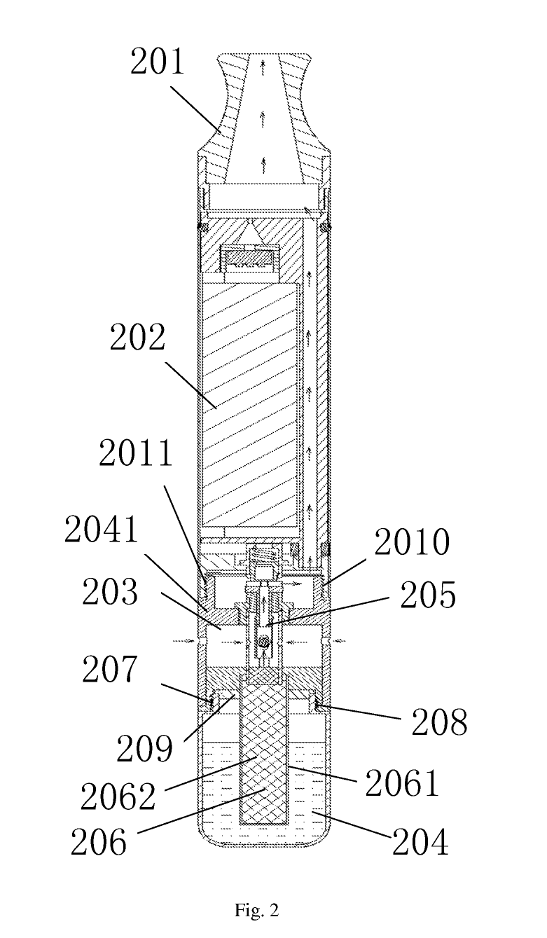

In the above embodiments, the liquid storage space is arranged inside the atomizer assembly. In practical application, a liquid bottle may also be provided in the electronic cigarette to store the cigarette liquid to be atomized by the atomizer assembly. Reference is made to FIG. 2, which is a schematic sectional view showing the structure of another embodiment of the electronic cigarette according to the present application.

Unlike the embodiment shown in FIG. 1, in this embodiment shown in FIG. 2, the smoking end 201 is arranged at an end of the battery assembly 202 away from the atomizer assembly 203. In addition, the electronic cigarette further includes a liquid bottle 204 connected to the end of the atomizer assembly 203 away from the battery assembly.

The cigarette liquid, which can be atomized, is stored in the liquid bottle 204. A liquid storage media is further provided in the liquid bottle 204. The liquid storage media is capable of storing and retaining the cigarette liquid, and preventing the cigarette liquid from flowing randomly. In practical application, the liquid bottle 204 may be a glass liquid bottle, a plastic liquid bottle, a metal liquid bottle or a ceramic liquid bottle. The liquid storage media may be made of at least one of cotton, wood pulp fiber or polyethylene glycol terephthalate. Of course, the above descriptions are just several examples of the liquid bottle and the liquid storage media, which are not intended to constitute limitation. In an electronic cigarette with a glass liquid bottle 204, a protective sleeve (not shown) is preferably sleeved on the liquid bottle 204 to avoid the situation that the liquid bottle 204 made of glass material may break when falling off.

The liquid bottle 204 is provided with an opening, and an end of the liquid bottle provided with the opening is connected to the atomizer assembly 203, thus the cigarette liquid in the liquid bottle 204 may be atomized by the atomizer assembly 203.

Unlike the atomizer assembly in the embodiment shown in FIG. 1, the atomizer assembly 203 in this embodiment includes an atomizing bracket 2041, an atomizing core 205 fixed in the atomizing bracket 2041 and configured to atomize the cigarette liquid, and a liquid guiding mechanism 206 for delivering the cigarette liquid in the liquid bottle 204 to the atomizing core 205 to be atomized

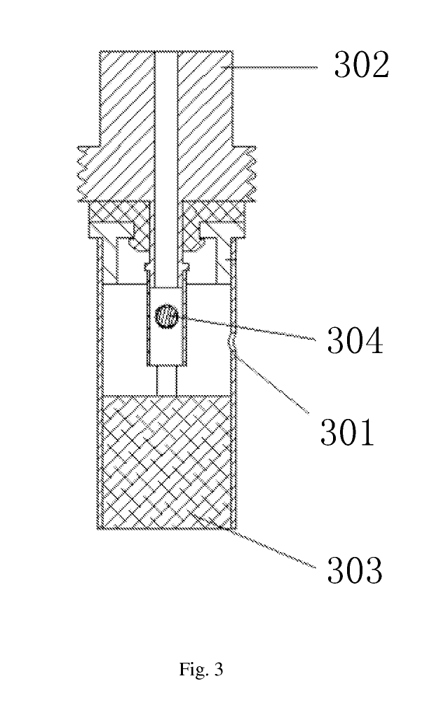

Reference is made to FIG. 3, which is a schematic sectional view showing the structure of the atomizing core in the electronic cigarette shown in FIG. 2. In this embodiment, the atomizing core 205 includes an atomizing sleeve 301, an atomizing electrode assembly 302, a liquid retaining member 303 and an electric heating wire assembly 304.

The atomizing electrode assembly 302 is arranged at an end of the atomizing sleeve 301 and configured to be electrically connected to the battery assembly 202. The liquid retaining member 303 is inserted inside the atomizing sleeve 301 and made of a liquid absorption material, such as liquid absorption cotton or liquid guiding fiber, which is not limited herein. The electric heating wire assembly 304 is arranged inside the atomizing sleeve 301, and is located between the atomizing electrode assembly 302 and the liquid retaining member 303, and is configured to be electrically connected to the atomizing electrode assembly 302, to allow the battery assembly 202 to supply power to the electric heating wire assembly 304.

Referring to FIG. 2, the liquid guiding mechanism 206 includes a liquid guiding sleeve 2061 inserted in the liquid bottle 204, and a liquid guiding member 2062 inserted in the liquid guiding sleeve 2061. The liquid guiding member 2062 is made of a liquid absorption material, such as liquid absorption cotton or liquid guiding fiber, which is not limited herein. When the atomizing core 205 and the liquid guiding mechanism 206 are connected to each other, the liquid retaining member 303 in the atomizing core 205 is connected to the liquid guiding member 2062 in the liquid guiding mechanism 206, and the cross-sectional area of the liquid retaining member 303 is smaller than the cross-sectional area of the liquid guiding member 2062. The cigarette liquid in the liquid bottle 204 sequentially passes through the liquid guiding member 2062 in the liquid guiding mechanism 206 and the liquid retaining member 303, and then reaches the electric heating wire assembly 304, and is atomized by the electric heating wire assembly 304.

In this embodiment, the dry heating of the electric heating wire assembly caused by supply shortage of the cigarette liquid can be avoided by arranging the liquid retaining member 303. Also, the cross-sectional area of the liquid retaining member 303 is smaller than the cross-sectional area of the liquid guiding member 2062, which may avoid the situation that the cigarette liquid is excessively delivered to the electric heating wire assembly, which may cause a part of the cigarette liquid failing to be atomized This structure can skillfully solve the problems of a conventional electronic cigarette of the unstable amount of smoke and dry heating of the electric heating wire assembly caused by fluctuations in the supply of the cigarette liquid.

Of course, the above description of the structure of the atomizer assembly is merely for exemplifying, and does not intend to limit the structure of the atomizer assembly.

Preferably, in this embodiment, the liquid bottle 204 and the atomizer assembly 203 are detachably connected to each other. In this way, it is convenient for the user to replace the liquid bottle or add the cigarette liquid into the liquid bottle.

Taking the embodiment shown in FIG. 2 as an example, a first threaded section 207 is provided on the atomizer assembly 203 at a portion where the atomizer assembly 203 is connected to the liquid bottle 204. Specifically, the first threaded section 207 is provided at an end of the atomizing bracket 2041 connected to the liquid bottle 204. An open end of the liquid bottle 204 is provided with first matching threads 208 configured to be connected to the first threaded section 207 by screw threads. The atomizer assembly 203 and the liquid bottle 204 are detachably connected to each other by the cooperation of the first threaded section 207 and the first matching threads 208.

Preferably, in this embodiment, the battery assembly and the atomizer assembly are detachably connected to each other. In this way, it is convenient for the user to replace the battery assembly or repair the electronic cigarette.

Taking the embodiment shown in FIG. 2 as an example, a second threaded section 2010 is provided on the atomizer assembly 203 at a portion where the atomizer assembly 203 is connected to the battery assembly 202. Specifically, the second threaded section 2010 is provided at an end of the atomizing bracket 2041 connected to the battery assembly 202. An end of the battery assembly 202 connected to the atomizer assembly 203 is provided with second matching threads 2011 configured to be connected to the second threaded section 2010 by screw threads. The atomizer assembly 203 and the battery assembly 202 are detachably connected to each other by the cooperation of the second threaded section 2010 and the second matching threads 2011.

In practical application, the atomizer assembly 203 and the liquid bottle 204, as well as the atomizer assembly 203 and the battery assembly 202, may also be detachably connected to each other in other ways, such as a snap fit connection. In this way, the connection structure on the atomizer assembly 203 is a snap-fit elastic strip with elasticity instead of the threaded section, and accordingly, the opening of the liquid bottle 204 or the end of the battery assembly 202 is provided with a structure for cooperating with the snap-fit elastic strip instead of the first matching threads. Of course, the above description is just an example, which does not intend to constitute limitation.

In this embodiment, in order to allow the liquid bottle 204 connected to the atomizer assembly 203 to have a good sealing performance to avoid leakage of the cigarette liquid in the liquid bottle 204, a sealing ring 209 with a through hole is preferably arranged at the opening of the liquid bottle 204, and the liquid guiding mechanism 206 is inserted into the liquid bottle 204 through the through hole of the sealing ring 209, to allow the sealing ring 209 and the liquid guiding mechanism 206 to seal the liquid bottle.

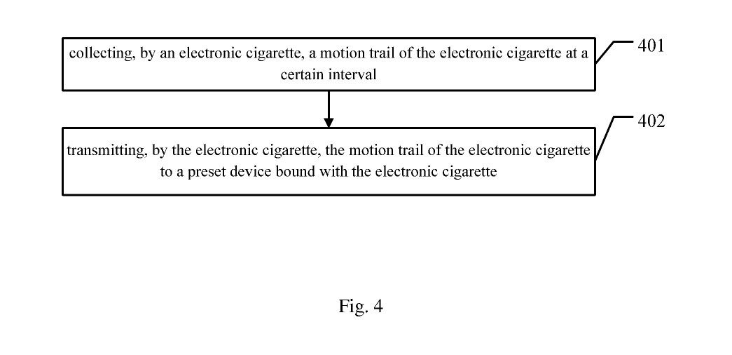

The electronic cigarette according to the embodiments of the present application is described hereinbefore, and a method for controlling the electronic cigarette according to the embodiments of the present application is described hereinafter. Referring to FIG. 4, an embodiment of the method for controlling the electronic cigarette according to the present application includes steps 401 and 402.

Step 401 may include collecting, by an electronic cigarette, a motion trail of the electronic cigarette at a certain interval.

The electronic cigarette may use many ways to collect the motion trail of the electronic cigarette at a certain interval. Specifically, a gyroscope, an acceleration meter and a microprocessor are provided in the electronic cigarette. The gyroscope collects a rotation angle of the electronic cigarette at a certain interval. It is to be noted that, each of the rotation angle and the acceleration includes a specific value and a specific direction, i.e., both of them are vector values. The acceleration meter collects an acceleration of the electronic cigarette at a certain interval. Further, at a certain interval, the gyroscope and acceleration meter respectively transmit the collected rotation angles and the collected accelerations to the microprocessor in the electronic cigarette. The microprocessor calculates the motion trail of the electronic cigarette according to the rotation angles and the accelerations of the electronic cigarette at a certain interval. The specific algorithm belongs to the conventional technology, which will not be described herein.

Of course, in practical application, the electronic cigarette may also collect the motion trail of the electronic cigarette at a certain interval in other ways, which is not limited herein.

Step 402 may include transmitting, by the electronic cigarette, the motion trail of the electronic cigarette to a preset device bound with the electronic cigarette.

In this embodiment, the preset device may be a device with a motion sensing game, such as a TV, a computer, a tablet computer or a cell phone, each of which has a motion sensing game, which is not limited herein.

In practical application, the electronic cigarette may be bound with the preset device by various ways. For example, the electronic cigarette is provided with a signal generating switch, and the electronic cigarette may transmit a signal when a user turns on the signal generating switch on the electronic cigarette. When the signal is detected by the preset device, the user may input a preset personal identification number (PIN) code to formally connect the electronic cigarette to the preset device. The electronic cigarette stores the information code trusted by the user terminal, and the electronic cigarette can be automatically formally connected and bound with the preset device when a signal transmitted by the electronic cigarette is detected by the preset device next time. Of course, the above example is merely a description and does not intend to constitute limitation.

In this embodiment, the electronic cigarette may transmit the motion trail of the electronic cigarette to the preset device by various ways. For example, the electronic cigarette may transmit the motion trail of the electronic cigarette to the preset device via Bluetooth transmission, WIFI transmission, infrared transmission or NFC transmission. Of course, in practical application, the motion trail of the electronic cigarette may also be transmitted in other ways, which is not limited herein.

In this embodiment, the motion trail of the electronic cigarette at a certain interval are collected and transmitted to the preset device bound with the electronic cigarette. Therefore, the electronic cigarette may act as a motion sensing game handle, and be used together with a smart device having a motion sensing game function. Due to the function extension of the electronic cigarette, the user experience of the electronic cigarette is enhanced.

In practical application, since the electronic cigarette may not always act as a motion sensing game handle, preferably, the electronic cigarette generally does not perform the step of collecting the motion trail of the electronic cigarette at a certain interval. The electronic cigarette starts to collect the motion trail of the electronic cigarette at every moment after it is detected by the electronic cigarette that a condition for starting the step is satisfied. Furthermore, the electronic cigarette stops collecting its own motion trail when it is detected by the electronic cigarette that a condition for stopping the step is satisfied.

For example, the electronic cigarette is provided with a button, and when the button is pressed, the condition for starting the step is satisfied, and the electronic cigarette starts to collect the motion trail of the electronic cigarette at every moment; and when the button is pressed again, the condition for stopping the step is satisfied, and the electronic cigarette stops collecting its own motion trail.

Preferably, the electronic cigarette starts to collect the motion trail of the electronic cigarette at a certain interval when it is detected by the electronic cigarette that the number of times of sucking the electronic cigarette within a preset duration is greater than a preset value. In this way, there is no need to arrange the button on the electronic cigarette, thereby reducing the physical cost, and avoiding occupying the space of the electronic cigarette with a small volume.

Further, preferably, the electronic cigarette controls a first program of the preset device to be activated and starts to collect the motion trail of the electronic cigarette at a certain interval when it is detected by the electronic cigarette that the number of times of sucking the electronic cigarette within a preset duration is greater than a first preset value and smaller than a second preset value. The electronic cigarette controls a second program of the preset device to be activated and starts to collect the motion trail of the electronic cigarette at a certain interval when it is detected by the electronic cigarette that the number of times of sucking the electronic cigarette within the preset duration is greater than the second preset value and smaller than a third preset value.

As an example, the first program and the second program of the preset device are respectively a primary stage and an advanced stage of a game in the preset device. The electronic cigarette controls the primary stage of the game in the preset device to be activated and starts to collect the motion trail of the electronic cigarette at every moment when it is detected by the electronic cigarette that the number of times of sucking the electronic cigarette by the user within one second is greater than 1 and smaller than 3. The electronic cigarette controls the advanced stage of the game in the preset device to be activated and starts to collect the motion trail of the electronic cigarette at every moment when it is detected by the electronic cigarette that the number of times of sucking the electronic cigarette by the user within one second is greater than or equal to 3 and smaller than 6.

Alternatively, the games in the preset device are divided into primary level games and advanced level games, the primary level games are games with less difficulty, and the advanced level games are games with high difficulty. The first program and the second program of the preset device are respectively a primary level game and an advanced level game in the preset device. Of course, the above description is just for exemplifying, and does not constitute limitation.

Preferably, the electronic cigarette stops collecting its own motion trail when it is detected that a duration of the electronic cigarette being placed horizontally or vertically is greater than a preset duration and the electronic cigarette is in a stationary state. In this way, the electronic cigarette stops collecting the motion trail when it is detected that the electronic cigarette is not being used, thus the user does not need to stop the step of the electronic cigarette manually, which can enhance the user experience.

The above embodiments are described in a progressive manner. Each of the embodiments is mainly focused on describing its differences from other embodiments, and references may be made among these embodiments with respect to the same or similar portions among these embodiments.

Based on the above description of the disclosed embodiments, the person skilled in the art is capable of carrying out or using the present application. It is obvious for the person skilled in the art to make many modifications to these embodiments. The general principle defined herein may be applied to other embodiments without departing from the spirit or scope of the present application. Therefore, the present application is not limited to the embodiments illustrated herein, but should be defined by the broadest scope consistent with the principle and novel features disclosed herein.

1. An electronic cigarette, comprising:
an electronic cigarette body;
wherein, the electronic cigarette body is provided with a smoking end, an atomizer assembly configured to atomize a cigarette liquid, and a battery assembly configured to supply power to the atomizer assembly; and
the electronic cigarette body is further provided with a detection module, a microprocessor and a wireless signal transmission module, and the detection module is configured to detect a rotation angle and an acceleration of the electronic cigarette body at a certain interval, the microprocessor is configured to calculate a motion trail of the electronic cigarette body according to a detection result of the detection module and transmit a calculation result to the wireless signal transmission module, and the wireless signal transmission module is configured to transmit the calculation result to a preset device bound with the electronic cigarette body.

2. The electronic cigarette according to claim 1, wherein the detection module comprises a gyroscope and an acceleration meter.

3. The electronic cigarette according to claim 1, wherein the wireless signal transmission module is a Bluetooth transmission module, a wireless fidelity (WIFI) transmission module, an infrared transmission module or a near field communication (NFC) transmission module.

4. The electronic cigarette according to claim 1, wherein the electronic cigarette body is further provided with a luminous element configured to indicate a working state of the detection module, the microprocessor and the wireless signal transmission module.

5. The electronic cigarette according to claim 4, wherein the atomizer assembly and the battery assembly are coaxially arranged, the smoking end is provided at an end of the atomizer assembly away from the battery assembly, and the luminous element is provided at an end of the battery assembly away from the atomizer assembly.

6. The electronic cigarette according to claim 1, wherein the battery assembly comprises a battery sleeve, a battery provided inside the battery sleeve, a sensing module configured to generate a triggering signal, and a microcontroller, and the microcontroller is configured to be electrically connected to the sensing module and configured to control the battery to supply power to the atomizer assembly according to the triggering signal.

7. The electronic cigarette according to claim 6, wherein the sensing module is further configured to transmit an activating signal to the microcontroller in the case that it is detected that the number of times of sucking the electronic cigarette within a preset duration is greater than a preset value; and the microcontroller is further configured to activate the detection module and the wireless signal transmission module according to the activating signal.

8. The electronic cigarette according to claim 1, wherein a liquid storage space configured to store the cigarette liquid, an atomizing core configured to atomize the cigarette liquid and to be electrically connected to the battery assembly, and a smoke passage configured to discharge smoke to the smoking end and extending along an axis of the atomizer assembly are provided in the atomizer assembly.

9. The electronic cigarette according to claim 8, wherein each of the detection module, the microprocessor and the wireless signal transmission module is arranged at an end of the battery assembly away from the liquid storage space.

10. The electronic cigarette according to claim 1, further comprising a liquid bottle connected to an end of the atomizer assembly away from the battery assembly;
wherein, the atomizer assembly comprises:
an atomizing bracket;
an atomizing core fixed in the atomizing bracket and configured to atomize the cigarette liquid, wherein the atomizing core comprises an atomizing sleeve, an atomizing electrode assembly arranged at an end of the atomizing sleeve and configured to be electrically connected to the battery assembly, a liquid retaining member provided inside the atomizing sleeve and made of a liquid absorption material, and an electric heating wire assembly arranged inside the atomizing sleeve and located between the atomizing electrode assembly and the liquid retaining member, and the electric heating wire assembly is electrically connected to the atomizing electrode assembly; and
a liquid guiding mechanism configured to deliver the cigarette liquid in the liquid bottle to the atomizing core to be atomized, wherein the liquid guiding mechanism comprises a liquid guiding sleeve inserted in the liquid bottle, and a liquid guiding member inserted in the liquid guiding sleeve and made of a liquid absorption material, and a cross-sectional area of the liquid retaining member is smaller than a cross-sectional area of the liquid guiding member.

11. The electronic cigarette according to claim 10, wherein the liquid bottle and the atomizer assembly are detachably connected to each other.

12. The electronic cigarette according to claim 10, wherein a sealing ring with a through hole is arranged at an opening of the liquid bottle, and the liquid guiding mechanism is inserted into the liquid bottle through the through hole of the sealing ring, to allow the sealing ring and the liquid guiding mechanism to seal the liquid bottle.

13. The electronic cigarette according to claim 1, wherein the battery assembly and the atomizer assembly are detachably connected to each other.

14. An information collection method, comprising:
collecting, by an electronic cigarette, a motion trail of the electronic cigarette at a certain interval; and
transmitting, by the electronic cigarette, the motion trail of the electronic cigarette to a preset device bound with the electronic cigarette.

15. The information collection method according to claim 14, wherein a gyroscope, an acceleration meter and a microprocessor are provided inside the electronic cigarette;
the collecting, by an electronic cigarette, a motion trail of the electronic cigarette at a certain interval comprises:
collecting, by the gyroscope in the electronic cigarette, a rotation angle of the electronic cigarette at a certain interval;
collecting, by the acceleration meter in the electronic cigarette, an acceleration of the electronic cigarette at a certain interval; and
calculating, by the microprocessor in the electronic cigarette, the motion trail of the electronic cigarette at a certain interval according to rotation angles and accelerations at a certain interval.

16. The information collection method according to claim 14, wherein the transmitting, by the electronic cigarette, the current motion trail of the electronic cigarette to a preset device bound with the electronic cigarette comprises:
transmitting, by the electronic cigarette, the current motion trail of the electronic cigarette to the preset device bound with the electronic cigarette via Bluetooth transmission, WIFI transmission, infrared transmission or NFC transmission.

17. The information collection method according to claim 14, further comprising:
starting to collect, by the electronic cigarette, the motion trail of the electronic cigarette at a certain interval in the case that it is detected that the number of times of sucking the electronic cigarette within a preset duration is greater than a preset value.

18. The information collection method according to claim 17, further comprising:
controlling, by the electronic cigarette, a first program of the preset device to be activated and starting to collect, by the electronic cigarette, the motion trail of the electronic cigarette at a certain interval in the case that it is detected that the number of times of sucking the electronic cigarette within the preset duration is greater than a first preset value and smaller than a second preset value; and
controlling, by the electronic cigarette, a second program of the preset device to be activated and starting to collect, by the electronic cigarette, the motion trail of the electronic cigarette at a certain interval in the case that it is detected that the number of times of sucking the electronic cigarette within the preset duration is greater than or equal to the second preset value and smaller than a third preset value.

19. The information collection method according to claim 14, further comprising:
stopping, by the electronic cigarette, collecting the motion trail of the electronic cigarette in the case that it is detected that a duration of the electronic cigarette being placed horizontally or vertically is greater than a preset duration and the electronic cigarette is in a stationary state.
